(19) United States
(12) Patent Application Publication
(10) Pub. No.: US 2004/0140649 A1
(43) Pub. Date: Jul. 22, 2004

(54) Easy use rack for trash, garbage, and miscellaneous items, to be used with plastic, paper, cloth bags, and other receptacles

(76) Inventor: Morton Faden, Boca Raton, FL (US)

Correspondence Address: MORTON FADEN, 2560 N.W. 53 ST., BOCA RATON, FL, 33496, US

(21) Appl. No.: 10/244,916

(22) Filed: Jan. 21, 2003

(51) Int. Cl. B62B 1/00

(52) U.S. Cl. 280/651; 248/98

(57) ABSTRACT

Our patent application applies to a new design concept, which employs a very simple rolling rack arrangement to collect commercial and home garbage and trash using standard disposable trash bags. The basic idea revolves around the concept that clean up is significantly simplified with a rack which can be rolled up to the collection point used and then simply stored away when no longer in use via a simple folding arrangement. The rack is to be made of standard tubing and standard commercially available casters. The entire assembly is easy to clean and store and can be used by the average homemaker or commercial establishment handling garbage of all kinds. Significant advantages are cleanliness in that the rack assembly is easy to clean and therefore sanitary, the garbage is protected with a plastic cover to retain fumes and odors and in general afford a clean appetence.

I, Morton Faden, have invented and designed a new concept for industrial, commercial and home garbage and trash and miscellaneous item collection, which can be used in a number of ways as, outlined in the following specification. The design involves a simple portable rack, which can be used to collect garbage, trash, leaves and grass clippings as well as other miscellaneous items, in standard plastic garbage bags or bags/receptacles of any other material. The rack is attractive, easy to use and keep clean. It is configured for use with standard disposable plastic bags. The bags are firmly retained in the portable rack with a single bracket and the bag, in use, is bedecked with a hinged cover.

The following attached drawings provide a general description of the structure of my invention:

Fig. A is an isometric of the rack

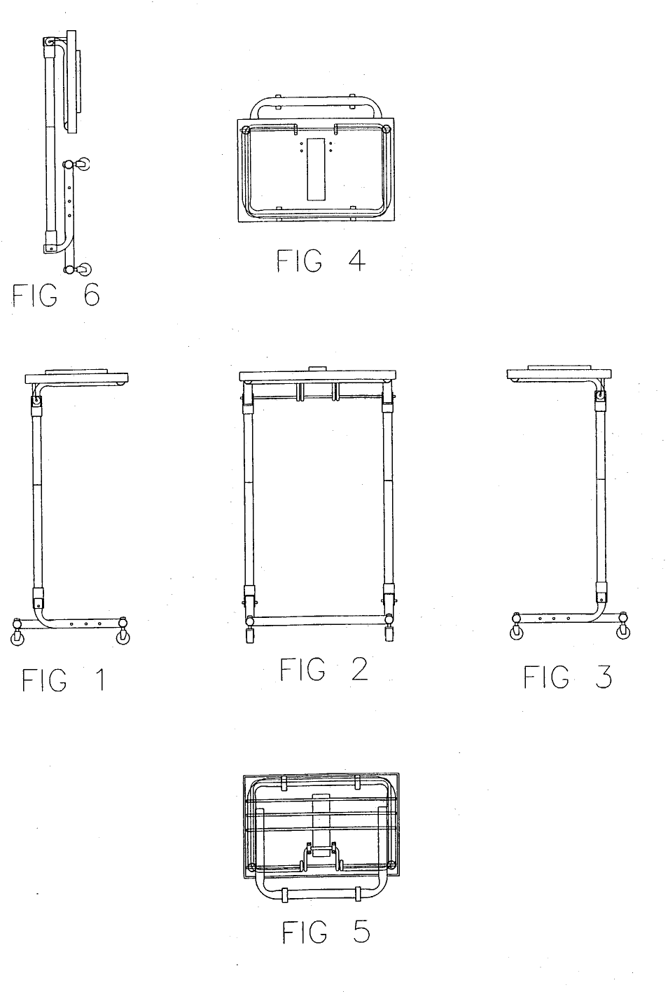

FIG. 1 is the left side elevation

FIG. 2 is front view elevation

FIG. 3 is the right view elevation

FIG. 4 is a top plan view

FIG. 5 is a bottom plan view

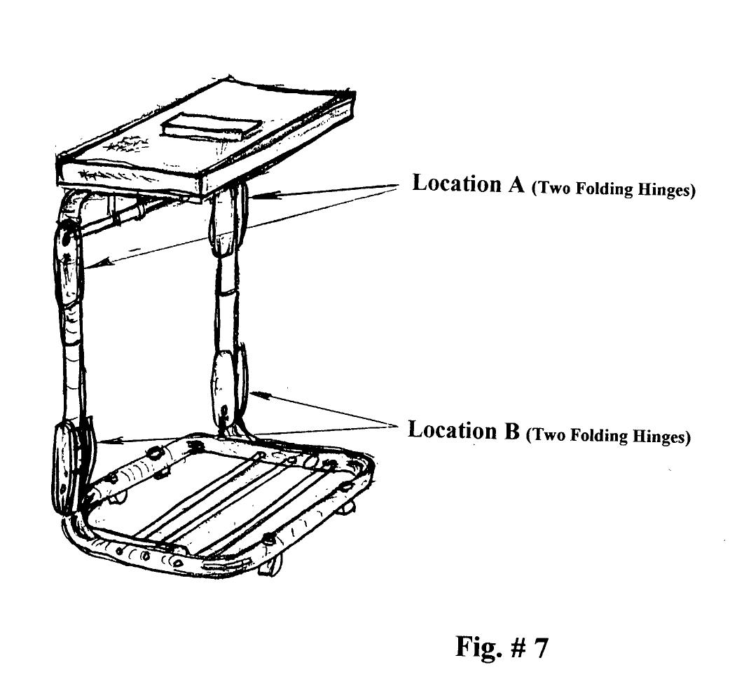

FIG. 6 is a side view in the shipping and storage configuration

FIG. 7 shows the suggested hinge locations

FIG. 8 is an annotated drawing of Fig. B with typical dimensions (for 32 gal bag)

Fig. B is a drawing summary for ease of reference

With respect to utility, my design includes a number of variations to the basic design depicted in the above listed drawings. Among the utility variations I plan are the following:

1) Basic 32-gallon plastic bag configuration, as shown, made of steel or plastic tubing.

2) A standard 20-gallon plastic garbage bag variation. The user accomplishes this by simply removing short inserts from the two main vertical struts of the cart.

3) A garden variety of the cart is planned with the use of two larger wheels in place of the shown rear caster and the addition of a cart handle front or back of the cart for ease of movement on grass or other irregular surfaces.

4) A food service utility cart with a stronger and more rigid construction made of stainless or other strong metal.

5) The item is adaptable to use with cloth and paper bags, or other receptacles in addition to the plastic bags identified above, of any size, by simply adjusting the height of the two vertical struts.

1. I designed a cart, to be made of metal tubing, for easy trash and garbage collection:

2. The cart I designed can be used with standard, commercially available, plastic or cloth bags.

3. My cart has casters for easy transport in kitchens, dinning rooms, and cafeterias and even on pavement and grass.

4. My cart will not retain spoiled garbage as do standard garbage cans.

5. My cart will stay clean and if soiled will be very easy to clean as all surfaces are exposed and accessible.
